(19) United States
(12) Patent Application Publication
(10) Pub. No.: US 2020/0110351 A1
(43) Pub. Date: Apr. 9, 2020

(54) IMAGE FORMING APPARATUS, DEVELOPING DEVICE, AND CONTROL METHOD OF IMAGE FORMING APPARATUS OR DEVELOPING DEVICE

(71) Applicant: Konica Minolta, Inc., Tokyo (JP)

(72) Inventor: Masanori KAWADA, Toyokawa-shi (JP)

(21) Appl. No.: 16/536,762

(22) Filed: Aug. 9, 2019

(30) Foreign Application Priority Data
Oct. 5, 2018 (JP) 2018-190176

(51) Int. Cl. G03G 15/08

(52) U.S. Cl. CPC G03G 15/0894; G03G 15/0889

(57) ABSTRACT

A developing device includes a container that includes first and second divisions that accommodate a developer, first and second passages that connect the first and second divisions, first and second stirring members that are to stir a developer in the first and second divisions respectively, the first and second stirring members including a rotation shaft and a spiral stirring part around the rotation shaft, a replenishment port that replenishes the container with a developer, a discharge port that discharges a developer from the container, and a developing roller that is to supply a developer stirred by an image carrier, wherein the first and second stirring members rotate to circulate a developer through the first and second passages, the discharge port is provided outside a circulation path of a developer in the first division, and the developing device further includes a discharged developer regulating part that regulates flow of a developer.

The entire disclosure of Japanese patent Application No. 2018-190176, filed on Oct. 5, 2018, is incorporated herein by reference in its entirety.

### BACKGROUND

### Technological Field

The present disclosure relates to control of an image forming apparatus, and more particularly to control of a developing device that is included in the image forming apparatus.

### Description of the Related Art

In an electrophotographic image forming apparatus, it is common to use a developing device that develops, with toner, a latent image formed on an image carrier formed by a photoreceptor or the like. In such a developing device, a two-ingredient developer containing toner and carrier is used. The developing device stirs the developer with a stirring member such as a screw in a developing housing, which is a container that accommodates the developer. Then, the stirred developer is conveyed to a surface of the image carrier by a roller-shaped developer carrier.

Since the toner is fixed to a non-transfer medium such as paper, the toner decreases with each use, but the carrier remains in the developing device without being consumed. As a result, the charge imparting performance of the carrier is lowered and deteriorated by being used for a long time. Therefore, it is necessary to suppress the deterioration of the charging performance of the developer as a whole, by newly replenishing the developing housing with the developer containing the carrier, and discharging an excess old developer.

As for the developing device, for example, JP 2011-175095 A discloses “a compact developing device that has a simple structure, stably discharges a surplus developer from a developing container, and accurately maintains an amount of the developer in the developing container to a desired amount, and discloses an image forming apparatus including the developing device” ([abstract]). Further, JP 2009-58898 A discloses “a developing device that effectively prevents a driving torque of a stirring-conveying means from increasing by developer plugging in accompaniment to discharge of an excessive developer, and prevents toner from being coagulated by simple constitution” ([abstract]).

According to the techniques disclosed in JP 2011-175095 A and JP 2009-58898 A, it is not possible to discharge a developer that has entered an end part of the developing housing without being discharged from a discharge port. Therefore, there is required a technique for effectively discharging a developer that has entered an end part of the developing housing.

### SUMMARY

The present disclosure has been made in view of the above background, and an object in one aspect is to provide a technique for effectively discharging an excess developer while replenishing a developer containing with a carrier.

To achieve the abovementioned object, according to an aspect of the present invention, a developing device reflecting one aspect of the present invention comprises a container that includes first and second divisions that accommodate a developer, first and second passages that connect the first and second divisions, first and second stirring members that are to stir a developer in the first and second divisions respectively, the first and second stirring members including a rotation shaft and a spiral stirring part around the rotation shaft, a replenishment port that replenishes the container with a developer, a discharge port that discharges a developer from the container, and a developing roller that is to supply a developer stirred by an image carrier, wherein the first and second stirring members that rotate to circulate a developer through the first and second passages, the discharge port is provided outside a circulation path of a developer in the first division, and the developing device further comprises a discharged developer regulating part that is provided downstream of the discharge port, and is to regulate flow of a developer into downstream of the discharge port in a direction from the circulation path toward the discharge port.

### BRIEF DESCRIPTION OF THE DRAWINGS

The objects, advantages, aspects, and features provided by one or more embodiments of the invention will become more fully understood from the detailed description given hereinbelow and the appended drawings which are given by way of illustration only, and thus are not intended as a definition of the limits of the present invention:

FIG. 1 is a view showing a configuration of an image forming apparatus according to a first embodiment;

FIG. 2 is a view showing a configuration of a developing device according to the first embodiment;

FIG. 3 is a cross-sectional view of a developing housing;

FIG. 4 is a cross-sectional view of the vicinity of a discharge port of the developing housing;

FIG. 5 is a view showing a configuration of a developing housing according to a second embodiment;

FIG. 6 is a view showing a configuration of a developing housing according to a third embodiment;

FIG. 7 is a view showing in detail a stirring member according to the third embodiment; and

FIG. 8 is a view showing an example of intermittent replenishment of the developing device.

### DETAILED DESCRIPTION OF EMBODIMENTS

Hereinafter, one or more embodiments of the technical idea according to the present invention will be described with reference to the drawings. However, the scope of the invention is not limited to the disclosed embodiments. In the following description, the same reference numerals are given to the same parts. Their names and functions are also the same. Therefore, detailed description thereof will not be repeated. Further, the features described in each embodiment may be combined as appropriate.

### First Embodiment

<A. Apparatus Configuration of Image Forming Apparatus>

First, an apparatus configuration of an image forming apparatus 100 according to the present embodiment will be described.

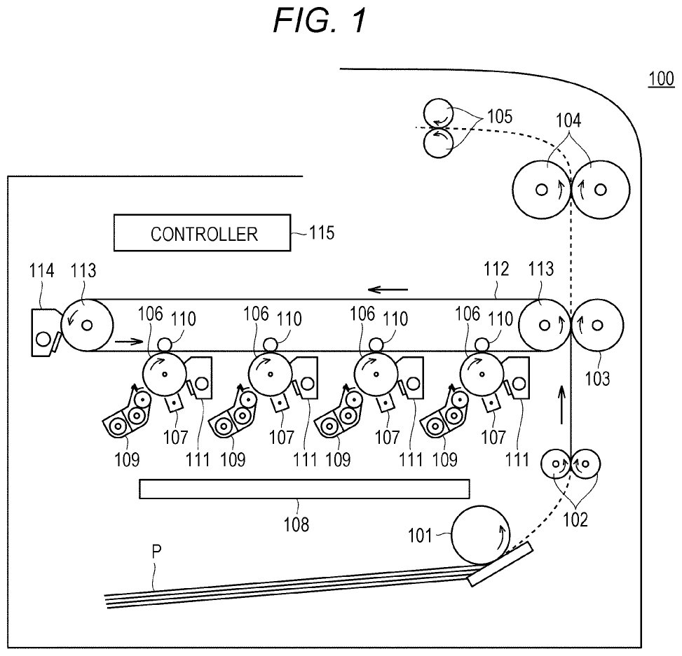

FIG. 1 is a view showing a configuration of the image forming apparatus 100 according to the present embodiment. Referring to FIG. 1, the image forming apparatus 100 includes a paper feeding roller 101, a timing roller 102, a secondary transfer roller 103, a fixing part 104, a paper discharging roller 105, an image carrier 106, a charging device 107, a latent image forming device 108, a developing device 109, a primary transfer roller 110, a first cleaning device 111, an intermediate transfer belt 112, a rotating roller 113, a second cleaning device 114, and a control part 115.

A flow of printing an image on paper P will be described. The paper feeding roller 101 conveys the paper P, which is a medium to be transferred, from a cassette rack. The timing roller 102 conveys the paper P to the secondary transfer roller 103 so as to match the transfer timing. The secondary transfer roller 103 transfers a toner image formed on the intermediate transfer belt 112 to the paper P, and conveys the paper P to the fixing part 104. The fixing part 104 heats and fixes the toner image on a surface of the paper P, and conveys the paper P to the paper discharging roller 105. Finally, the paper discharging roller 105 discharges the paper P to a tray.

Next, a flow until formation of a toner image of an image to be printed on the paper P will be described. In the image forming apparatus 100 that handles color images, the image carrier 106 such as a photoreceptor forms a toner image of each of colors of cyan, magenta, yellow, and black. The charging device 107 charges the entire surface of the image carrier 106. The latent image forming device 108 forms a latent image by partially inverting the charge on the surface of the charged image carrier 106 by a laser beam or a light emitting diode (LED). To a part where the charge is inverted on the surface of the image carrier 106, the toner is adsorbed.

The developing device 109 causes the charged toner to be adsorbed on the surface of the image carrier 106, to form a toner image. By stirring the developer containing the toner and the carrier in advance, the developing device 109 charges oppositely to that of the part where the charge is inverted on the surface of the image carrier 106 by the latent image forming device 108. This allows the toner to be adsorbed on the part where the latent image has been formed by the latent image forming device 108, on the surface of the image carrier 106.

The primary transfer roller 110 transfers the toner image formed on the surface of the image carrier 106 to the intermediate transfer belt 112. The primary transfer roller 110 sequentially transfers color toner images of cyan, magenta, yellow, and black to the intermediate transfer belt 112 to form a color toner image. The first cleaning device 111 removes residual toner attached to the surface of the image carrier 106 after transfer of the toner image to the intermediate transfer belt 112.

The image forming apparatus 100 described in the present embodiment is an image forming apparatus that handles color images. Therefore, the image carrier 106, the charging device 107, the latent image forming device 108, the developing device 109, the primary transfer roller 110, and the first cleaning device 111 are provided for four colors. They are yellow (Y), magenta (M), cyan (C), and key plate (K), individually. Note that the technique described in the present embodiment is also applicable to a monochrome image forming apparatus.

The rotating roller 113 stretches and supports the intermediate transfer belt 112, and rotates to convey a toner image formed on the intermediate transfer belt 112, to a position where the secondary transfer roller 103 is located. The second cleaning device 114 removes residual toner remaining on the intermediate transfer belt 112 after transfer of the toner to the paper P.

<B. Configuration of Developing Device>

Next, a detailed configuration of the developing device 109 according to the present embodiment will be described.

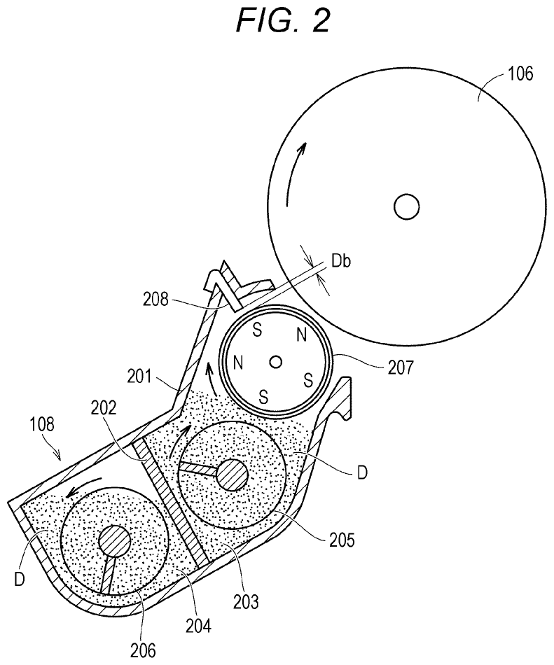

FIG. 2 is a view showing a configuration of the developing device 109 according to the present embodiment. Referring to FIG. 2, the developing device 109 includes a developing housing 201, a partition wall 202, a first developer conveying part 203, a second developer conveying part 204, a first stirring member 205, a second stirring member 206, a developer carrier 207, and a regulating member 208.

The developing device 109 accommodates a developer D containing toner and a carrier, in the developing housing 201. The developing housing 201 is divided by the partition wall 202 into two divisions of the first developer conveying part 203 and the second developer conveying part 204. The first stirring member 205 stirs and conveys the developer in the first developer conveying part 203. The second stirring member 206 stirs and conveys the developer D in the second developer conveying part 204. The first stirring member 205 and the second stirring member 206 may be a screw having a spiral blade on a rotation shaft.

In addition, the partition wall 202 includes, for example, passages (not shown) near both axial ends of the first stirring member 205 and the second stirring member 206. The developer D is conveyed so as to circulate between the first developer conveying part 203 and the second developer conveying part 204 via these passages.

Further, the first stirring member 205 supplies the developer D in the first developer conveying part 203 to an outer peripheral surface of the developer carrier 207. A magnet member is provided on an inner peripheral side of the developer carrier 207, and the magnetic force of the magnet member holds the conveyed developer D on the outer peripheral surface of the developer carrier 207.

By rotating, the developer carrier 207 conveys the developer D held on the outer peripheral surface of the developer carrier 207, toward a development region facing a photoreceptor drum 10. The regulating member 208 is attached to the developing housing 201 so as to face the outer peripheral surface of the developer carrier 207 via a required distance Db. The regulating member 208 regulates an amount of the developer D that is held on the outer peripheral surface of the developer carrier 207 and conveyed to the developing area.

The developer carrier 207 is provided such that respective outer peripheral surfaces of the developer carrier 207 and the image carrier 106 face each other with a required distance. The developer carrier 207 supplies the developer D whose amount is adjusted by the regulating member 208, to the outer peripheral surface of the image carrier 106.

<C. Configuration of Developing Housing>

Next, conveyance of the developer in the developing housing 201 according to the present embodiment will be described.

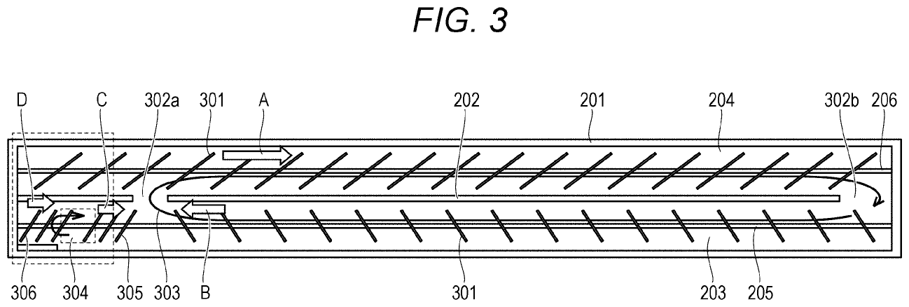

FIG. 3 is a cross-sectional view of the developing housing 201 as viewed in a direction perpendicular to an axis of the stirring member. The first stirring member 205 and the second stirring member 206 have a screw shape, and individually include a blade 301 around a rotation shaft. Near both ends of the partition wall 202, there are a passage 302a and a passage 302b. The first stirring member 205 stirs and conveys the developer D in the direction of arrow B, and the second stirring member 206 stirs and conveys the developer in the direction of arrow A. This causes the developer D to be stirred and conveyed along a circulation path 303.

The discharge port 304 is a discharge port to discard an excess developer in the developing housing 201. In the developing housing 201, a replenishment port (not shown) to supply the developer D is also separately provided. A circulated-developer regulating part 305 is for regulating an amount of the developer D flowing from the circulation path 303 into the discharge port 304. The circulated-developer regulating part 305 may be, for example, a blade provided on a rotation shaft of the first stirring member 205. In this case, a rotation direction of the circulated-developer regulating part 305 is reverse to that of the blade 301 of the first stirring member 205. The developer D having reached the discharge port 304 beyond the circulated-developer regulating part 305 is exclusively discharged from the circulation path 303.

However, due to an unexpected inclination or the like, the developer D flowing from the circulation path 303 toward the discharge port 304 may flow into further downstream beyond the discharge port 304. This may require a large torque for the rotation of the first stirring member 205 due to a cause such as clogging with the developer D at a root of the rotation shaft of the first stirring member 205, and may cause problems such as an increase in power consumption and a decrease in service life of parts. Therefore, in the developing housing 201 according to the present embodiment, there is provided, on downstream of the discharge port 304, a discharged developer regulating part 306 that is to return the developer D having flowed beyond the discharge port 304 toward the discharge port 304.

<D. Configuration of Discharged Developer Regulator>

Next, the discharged developer regulating part according to the present embodiment will be described.

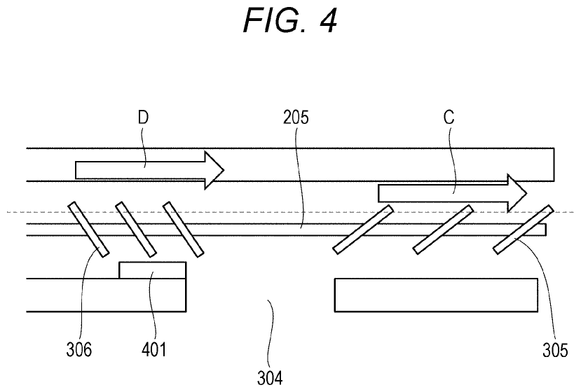

FIG. 4 is a cross-sectional view of the vicinity of the discharge port 304 of the developing housing 201. The discharged developer regulating part 306 is wound reversely to the blade 301 of the first stirring member 205, and inhibits clogging with the developer D at the root of the rotation shaft of the first stirring member 205, by pushing back the developer D having flowed into the downstream side to the discharge port 304. Further, instead of the discharged developer regulating part 306, a step 401 may be provided downstream of the discharge port 304. Alternatively, both of the discharged developer regulating part 306 and the step 401 may be provided.

As described above in detail, according to the image forming apparatus 100 according to the present embodiment, by providing the discharged developer regulating part 306 or the step 401 downstream of the discharge port 304, it is possible to suppress an increase in torque for rotating the first stirring member 205 due to flowing of the developer into the root of the first stirring member 205.

### Second Embodiment

Hereinafter, a second embodiment will be described. An image forming apparatus according to the second embodiment differs from the image forming apparatus according to the first embodiment in terms of an internal configuration of a developing housing.

<E. Another Configuration of Developing Container>

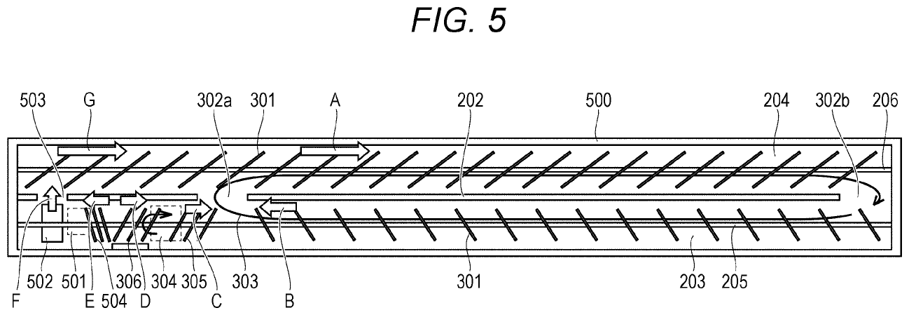

FIG. 5 is a view showing a configuration of a developing housing 500 according to the present embodiment. The same configurations as in FIG. 3 are denoted by the same reference numerals, and the description will not be repeated. Further, the image forming apparatus according to the present embodiment may or may not include a step 401 (not shown).

Referring to FIG. 5, in addition to a configuration of a developing housing 201, the developing housing 500 includes a replenishment port 501, a conveyance member 502, a passage 503, and a replenishment developer regulating part 504. The replenishment port 501 is provided downstream of a discharge port 304 in a direction from a circulation path 303 toward the discharge port 304. The conveyance member 502 is, for example, a blade-shaped paddle provided on a rotation shaft of a first stirring member 205, and is located further downstream of the replenishment port 501. By rotating, the conveyance member 502 feeds a developer D supplied from the replenishment port 501, to a second developer conveying part 204 via the passage 503. The replenishment developer regulating part 504 is a spiral blade provided on the rotation shaft of the first stirring member 205, and has the same direction as a blade 301. The replenishment developer regulating part 504 is for inhibiting a flow of the replenished developer D into the discharge port 304.

The developer D fed into the second developer conveying part 204 is conveyed to the circulation path 303 while being stirred by the blade 301 provided on a rotation shaft of a second stirring member 206. The developer D replenished from the replenishment port 501 is to be conveyed while being stirred until reaching the circulation path 303 on a long path indicated by arrows F and G. Therefore, even if there is a lump in the replenished developer D, the lump is to be dissolved, and the developer D can be more efficiently mixed with a developer D that is originally present in the circulation path 303.

As described above, the image forming apparatus according to the present embodiment includes the developing housing 500. By effectively utilizing an area downstream of the circulated-developer regulating part 305, it becomes easy to keep the charge imparting performance of the developer D uniform, while inhibiting a flow of the developer D into the root of the first stirring member 205.

### Third Embodiment

<F. Another Configuration of Developing Container>

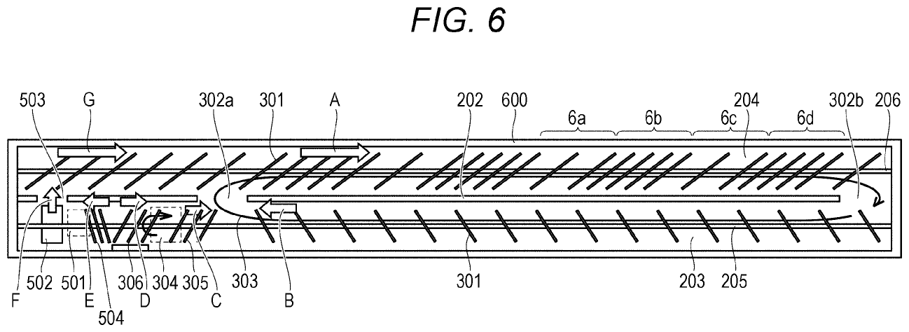

FIG. 6 is a view showing a configuration of a developing housing 600 according to the present embodiment. The same configurations as in FIGS. 3 and 5 are denoted by the same reference numerals, and the description will not be repeated. Further, there may or may not be a step 401 (not shown).

In the developing housing 600 according to the present embodiment, a number of strips or a pitch of at least one spiral blade of a first stirring member 205 or a second stirring member 206 is not constant. In the example of FIG. 6, divisions 6a and 6c of the second stirring member 206 have less strips, and divisions 6b and 6d have more strips.

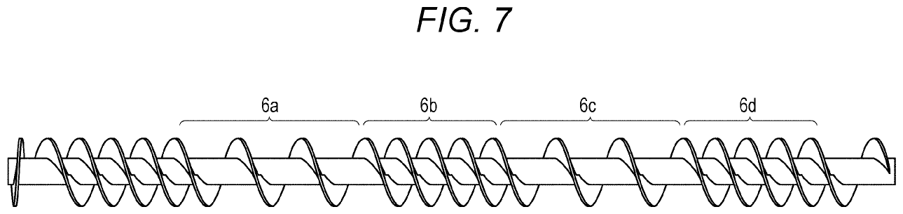

FIG. 7 is a view showing details of a stirring member according to the present embodiment. In the example of FIG. 7, it can be seen that the second stirring member 206 is a screw having different numbers of strips depending on divisions. By using such a screw having different numbers of strips in divisions as described above, it is possible to change a conveyance speed of a developer D in each division. This makes it easy to efficiently mix the developer D of adjacent divisions in a short time, and to maintain the charge imparting performance uniform.

### Fourth Embodiment

A method to replenish the developer to the developing device in the first to third embodiments will be described. The image forming apparatus 100 of FIG. 1 includes the developing devices 109 for four colors of Y, M, C, and K. Each developing device 109 is adjacent to a replenishment device (not shown) for replenishment of the developer. A motor (not shown) that drives these replenishment devices can simultaneously drive two replenishment devices and replenish two color developers simultaneously. Further, by switching a rotation direction, the replenishment device to be driven can be switched.

Driving of the replenishment device here means rotational driving of a screw or the like that is for stirring and conveying of the developer D, which is inside the replenishment device. The developer D conveyed from the replenishment device is replenished to the developing device 109 via the replenishment port 501.

For example, the replenishment devices of the developing devices 109 of Y and C can be driven by a forward rotation of the motor, and the replenishment devices of the developing devices 109 of M and K can be driven by a reverse rotation of the motor. While the motor rotates forward to replenish the developing devices 109 of Y and C with the developer D, the replenishment devices of the developing devices 109 of M and K are not driven but stopped. While the motor reversely rotates to replenish the developing devices 109 of M and K with the developer D, the replenishment devices of the developing devices 109 of Y and C are not driven but stopped. Note that which of the replenishment devices is driven by the forward rotation and the reverse rotation of the motor is a design matter, and may be appropriately selected.

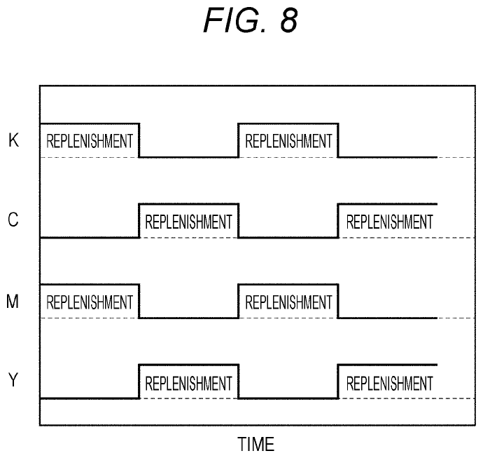

FIG. 8 is a view showing an example of intermittent replenishment of the developing device 109. For example, forward rotation of one motor drives the replenishment devices of the developing device of K and the developing device of M, and a reverse rotation drives the replenishment devices of the developing device of C and the developing device of Y, to perform intermittent replenishment.

In a case of the method in the present embodiment, K and M are not able to be replenished simultaneously with C and Y because one motor drives two replenishment devices. However, by adopting the configurations of the first to third embodiments, it is possible to maintain the stirring performance, and to achieve high quality and long life of the developing device and the image forming apparatus, without increasing the torque of the motor at the time of rotational driving of the first stirring member 205 and the second stirring member 206 even when a large amount of toner is replenished intermittently.

According to an embodiment of the present technology, it becomes possible to reliably discharge an excess developer without accumulating the developer at an end part of a developing housing, while replenishing with the developer.

Although embodiments of the present invention have been described and illustrated in detail, the disclosed embodiments are made for purposes of illustration and example only and not limitation. The scope of the present invention should be interpreted not by the description above but by terms of the appended claims, and it is intended to include all modifications within the meaning and scope equivalent to the claims

What is claimed is:

1. A developing device comprising:
a container includes first and second divisions that accommodate a developer;
first and second passages that connect the first and second divisions;
first and second stirring members that are to stir a developer in the first and second divisions respectively, the first and second stirring members including a rotation shaft and a spiral stirring part around the rotation shaft;
a replenishment port that replenishes the container with a developer;
a discharge port that discharges a developer from the container; and
a developing roller that is to supply a developer stirred by an image carrier, wherein
the first and second stirring members that rotate to circulate a developer through the first and second passages,
the discharge port is provided outside a circulation path of a developer in the first division, and
the developing device further comprises
a discharged developer regulating part that is provided downstream of the discharge port, and is to regulate flow of a developer into downstream of the discharge port in a direction from the circulation path toward the discharge port.

2. The developing device according to claim 1, wherein the discharged developer regulating part includes a step with respect to the circulation path.

3. The developing device according to claim 1, wherein the discharged developer regulating part is provided on a rotation shaft of the first stirring member, and has a spiral shape of a direction reverse to a stirring part of the first stirring member.

4. The developing device according to claim 2, wherein the replenishment port is located downstream of the discharge port in a direction from the circulation path toward the discharge port, and there is a third passage connecting the first and second divisions further downstream of the replenishment port.

5. The developing device according to claim 4, wherein the second stirring member conveys, to the circulation path, a developer having flowed into outside the circulation path of the second division, via the third passage.

6. The developing device according to claim 4, further comprising a replenishment developer regulating part that regulates a flow of a developer replenished from the replenishment port toward the discharge port, the replenishment developer regulating part being on a rotation shaft of the first stirring member between the replenishment port and the discharge port, wherein
the replenishment developer regulating part has a spiral shape in a same direction as that of a stirring part of the first stirring member.

7. The developing device according to claim 4, further comprising a developer conveying part on a rotation shaft of the first stirring member, wherein
the developer conveying part is provided near the third passage, and conveys, from the third passage to the second division, a developer replenished from the replenishment port by rotation of the first stirring member.

8. The developing device according to claim 1, wherein a number of strips of a stirring part in the circulation path of at least one of the first stirring member of the second stirring member is not constant.

9. The developing device according to claim 1, further comprising a circulated-developer regulating part that is disposed in a division between the discharge port on a rotation shaft of the first stirring member and the circulation path, the circulated-developer regulating part being for suppression of a flow of a developer in the circulation path into the discharge port, wherein
the circulated-developer regulating part has a spiral shape of a direction reverse to a stirring part of the first stirring member.

10. An image forming apparatus comprising:
a plurality of the developing devices according to claim 1;
a plurality of replenishment devices that are to replenish the respective developing devices with a developer; and
a driver that drives the plurality of replenishment devices, wherein
the driver switches the plurality of replenishment devices to be driven by changing a rotation direction.

11. A control method of a developing device that supplies a stirred developer to an image carrier, the control method comprising:
stirring and circulating a developer in a circulation path formed by a first division and a second division that are connected by two or more passages;
discharging a developer flowing into outside the circulation path, to a discharge port; and
returning, toward the discharge port, a developer having flowed downstream of the discharge port in a direction from the circulation path to the discharge port.

12. The control method according to claim 11, wherein returning, toward the discharge port, a developer flowing into downstream of the discharge port includes returning a developer toward the discharge port by a step provided downstream of the discharge port.

13. The control method according to claim 11, wherein returning, toward the discharge port, a developer flowing into downstream of the discharge port includes returning a developer toward the discharge port with stirring by a regulating member provided with a spiral blade on a rotation shaft.

14. The control method according to claim 11, further comprising replenishing with a developer from a replenishment port located downstream of the discharge port in a direction from the circulation path to the discharge port, and conveying a replenished developer to the circulation path from a passage further downstream of the replenishment port.

15. The control method according to claim 14, wherein conveying a replenished developer to the circulation path includes conveying to the circulation path by a spiral stirring member.

16. The control method according to claim 14, further comprising returning a developer toward the replenishment port when a developer replenished from the replenishment port flows toward the discharge port.

17. The control method according to claim 14, further comprising feeding a developer replenished from the replenishment port to a passage further downstream of the replenishment port, by rotating a blade provided on a rotation shaft near a passage further downstream of the replenishment port.

18. The control method according to claim 11, wherein stirring and circulating a developer in the circulation path further includes performing by using a spiral stirring member whose number of strips is not constant.

19. The control method according to claim 11, further comprising returning a developer having flowed in a direction from the circulation path to the discharge port, to the circulation path upstream of the discharge port.

20. A control method of an image forming apparatus comprising a first developing device and a second developing device, the control method comprising:
in the first developing device and the second developing device,
stirring and circulating a developer in a circulation path formed by a first division and a second division that are connected by a plurality of passages;
discharging a developer flowing into outside the circulation path, to a discharge port; and
returning, toward the discharge port, a developer having flowed downstream of the discharge port in a direction from the circulation path to the discharge port,
the control method further comprising:
in the image forming apparatus,
driving a first replenishment device by a forward rotation of a motor, to replenish the first developing device with a developer; and
driving a second replenishment device by a reverse rotation of a motor, to replenish the second developing device with a developer.
